(19) United States
(12) Patent Application Publication
(10) Pub. No.: US 2002/0021804 A1
(43) Pub. Date: Feb. 21, 2002

(54) System and method for data encryption

(76) Inventors: Robert C. Ledzius, Austin, TX (US); Stephen H. Kelley, Austin, TX (US)

Correspondence Address: Andrew G. DiNovo, VINSON & ELKINS L.L.P., 2300 First City Tower, 1001 Fannin Street, Houston, TX, 77002-6760, US

(21) Appl. No.: 09/785,772

(22) Filed: Feb. 16, 2001

Related U.S. Application Data
(60) Provisional application No. 60/183,705, filed on Feb. 18, 2000.

(51) Int. Cl. H04L 9/00; H04L 9/32; G06F 11/30

(52) U.S. Cl. 380/44; 380/45; 380/281; 380/283; 713/161; 713/168; 713/170; 713/171; 713/200; 713/201

(57) ABSTRACT

A system and method of private, three-key data encryption, secure storage, secure transmission and decryption is disclosed. The system is comprised of three core components, including a data server, a user device and a security server. The data server and user device have private security keys associated therewith. A third key is generated at the security server. The third key is transmitted to the data server and user device in encrypted form, using the data server security key to encrypt the third key as it is transmitted to the data server, and the user device security key to encrypt the third key as it is transmitted to the user device. As a result, a secure data transmission session may be established.

### FIELD OF THE INVENTION

The invention relates generally to the field of data encryption, and more specifically to a system and method for data encryption, secure transmission and decryption utilizing three keys held by a security server, a data server and a user device.

### BACKGROUND AND RELATED ART

It is well known in the art that computer systems are often the subject of unauthorized access, even with firewalls and security measures in place. Skilled “hackers” are sometimes able to infiltrate systems without anyone knowing they were there. Firewalls have become even more limited in their ability to control system and file access with the growth of thin, client-server based Application Service Providers (“ASPs”). The ASP model allows for users to subscribe to web based application software instead of purchasing, maintaining, and managing the application software themselves on their own machine. Consequently, one user's sensitive data may coexist on the same server as a competitor user's data, bringing the data one step closer to damage from unauthorized access. In order for ASPs to gain the trust of potential customers, there is a critical need to assure the user that its data will be protected through encryption and data access management.

The primary means of protecting data in the prior art has been data encryption and associated decryption keys. Data encryption is the translation of data into a form that is unintelligible without a deciphering mechanism. A key may be a password or other unique identifier.

Historically, secure transmission of documents used single key encryption, where both the sender of a document and the receiver of the document had the “key” used to encrypt and decrypt documents. The key would be delivered to the receiver of a document using some secure means of transmission, often in a manner as slow as a physical delivery. The secure transmission of the key was difficult over a computer network, so other methods were developed which could be used over communication networks where eavesdroppers could conceivably tap transmissions.

More recent prior art encryption systems have adopted a two key approach. A “public” key is made more or less generally available, whereas a “private” key is kept in an environment that is intended to be secure. The public key is used to encrypt a message, and the private key to decrypt the message. Both the public key and the decryption method can be known, but messages remain difficult to decrypt without the private key. Public keys are often stored in databases, such as “key certificate authorities,” that are trusted by the users. If the public key is not obtained from a trusted source, a third party could substitute its public key, and thereby decrypt message with its private key.

While reasonably effective, such prior art systems suffer from the fact that if the private key and decryption method are discovered, whether through hacking, reverse engineering or other means, the encrypted information will be relatively easy to decipher. Moreover, key certification authorities, as repositories of private encryption keys, provide attractive targets for would-be-hackers.

In addition, prior art approaches do not reflect the present-day realities of distributed networks. Server-side processing and applications may be complex. Client-side computers, however, are typically far less powerful in terms of processing capability and storage. Consequently, a solution which favors a server or other powerful machine for the majority of its encryption processing is generally preferable. This trend will continue as computing functions are carried over into the wireless arenas of PDAs and other handheld devices, where computing power is minimal.

Furthermore, prior art hardware solutions have typically used fixed encryption/decryption algorithms. If a method of encryption was hacked or broken, the solution for hackers could be published with potentially disastrous consequences.

It has therefore become desirable to have a new, improved system and method for encryption, storage, transmission and decryption of data in a secure fashion, as more fully discussed below.

### BRIEF DESCRIPTION OF THE DRAWINGS

The present invention is illustrated by way of example and not limitation in the accompanying figures, in which like references indicate similar elements, and in which:

FIG. 1 shows a simplified functional block diagram of the primary components of the present invention, along with a process flow for a secure session; and

FIG. 2 is a simplified functional block diagram of the primary components of the client-side process of an embodiment the present invention.

### DESCRIPTION OF THE PREFERRED EMBODIMENT

The following discussion is intended to provide a detailed description of at least one embodiment of the invention and should not be taken to be limiting of the invention itself. Rather, any number of variations may fall within the scope of the invention which is properly defined in the claims following this description.

The present invention is a system and method for encrypting, securely transmitting, receiving and decrypting data using three security keys. In a preferred embodiment, all three keys are private, meaning that they are not available to other parties, even within the communication loop. The invention addresses the changing demand for encryption, insofar as client devices are becoming increasingly light in terms of processing capabilities, and consequently demands made on the client for encryption processing are reduced.

A key feature of the present invention is its three private-key approach, which has not been adopted heretofore. Essentially, encryption may be desired whenever data is stored on a computer, or whenever two or more computer systems are communicating sensitive data between one another over a transmission line. In the system and method of the present invention, a third party is implicated in the communication link to authenticate and authorize the secure transaction, and to act as a secure reposition for a third encryption key. Using a preferred embodiment of the present invention, Internet and application service providers, as well as individual users of those services, can be assured that their valuable sensitive data, regardless of what the data is or where it is stored, is protected against compromise due to unauthorized access. This may all be done with minimal, if any, affect on users (i.e., those storing, sending and receiving data) directly.

In the preferred embodiment, on or more of the three keys may be contained in reconfigurable hardware. Performance and adaptability are two advantages of this hardware-based embodiment of the present invention. Performing cryptography (encryption and decryption) tasks in software can significantly affect server performance, making hardware acceleration of cryptography solutions a requirement for the server environment. This is especially true since industry demand for encryption of large files instead of small data packets is increasing.

One example of the use of an embodiment of the system and method of the present invention is the Quick Qard reconfigurable computing Technology (“QQT”), marketed by Quickflex, Inc. QQT's “soft” hardware, which is called “QardWare,” is reconfigurable and can be changed through software, allowing it to perform many different hardware algorithms, even those that have not yet been invented. This technology may be built into portable PC cards, so that high performance cryptography can be applied to users using portable PC's if required for high bandwidth connectivity encryption with applications such as full motion video. Persons of ordinary skill in the art will recognize, however, that the present invention may be implemented in software which will also provide many security advantages over prior art two key systems.

As stated above, an additional element of the system of the present invention is a server/user independent service used for validation of secure links. This validation service addresses the privacy needs of both service providers and individual users. Whenever a secure link is to be established, the system can validate endpoints in the communication link, and supply keys to use in order to securely transfer data. This service operates as a trust company for insuring neither party's data or interests are compromised. The validation service site only provides keys for secure communications, but the data transmitted between parties is not passed through the validation site, but is kept private between the two sides of the link. Service providers have the option to specify the level of verification users are required to have in order to be validated, such as ID's and passwords, fingerprint ID, retina ID, Smart Card, or any combination of these and other verification methods. Information for validating users is kept private between the validation site and users. Likewise, server sites are validated for users, insuring that data being sent by users in the secure link can only be used by that site and no other onlookers. Validation information for server based providers is also kept confidential with the validation site. Service providers only have to trust one company with their server encryption methods and keys to insure maximum security for their customers and users.

With the validation site solution, dangers of viruses are diminished, as hackers would have to hack the security, introduce the virus, then re-hack the system to introduce the infected file. Limitations of firewalls are largely overcome by storing data in encrypted form, and thereby insuring that data remains uncompromised in the event of a hack. Authentication and validation of users is made stronger through the validation site. Performance degradation of performing strong cryptography solutions is solved with hardware acceleration. Key recovery options are selectable by data owners. Security is made stronger through a trust site validation of users and generations of keys.

General Description of the System Architecture of the Preferred Embodiment

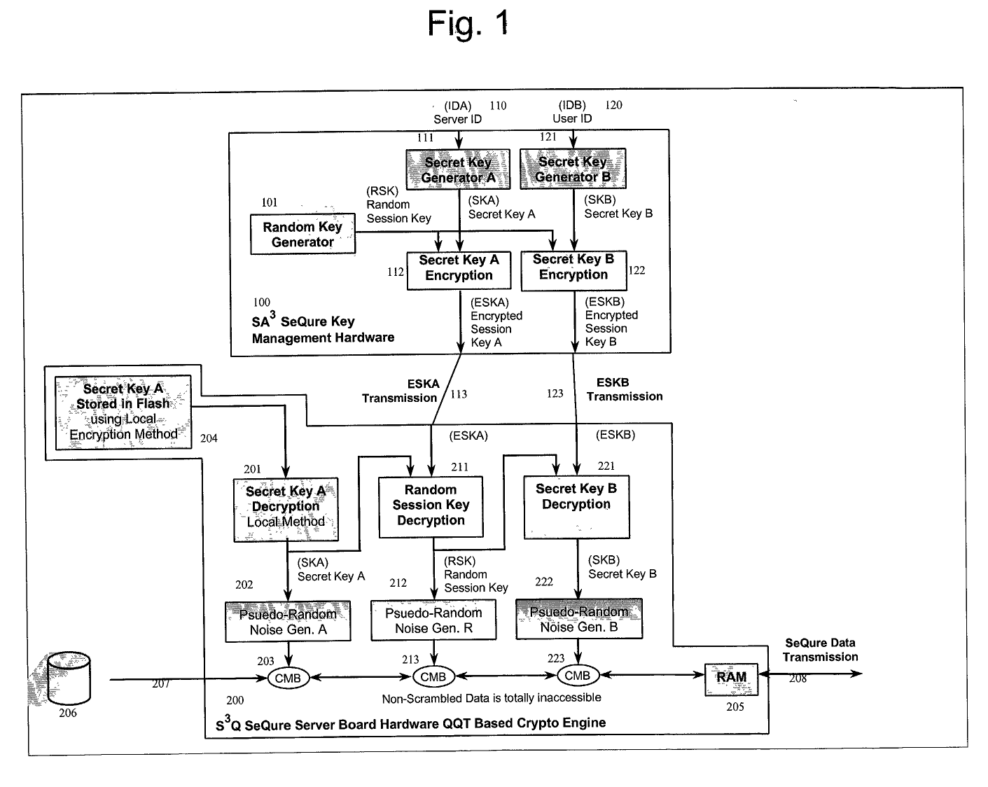

Referring now to FIG. 1, the system is made up of the following main elements:

1. Authentication, Authorization and Administration website service (“SA3”);

2. Data Server with PCI Board (“S3Q”); and

3. User Computer with User Authentication Device (“UAD”).

While the system and method of the present invention are discussed in terms of these specific components, a person of ordinary skill in the art will recognize that they are used for convenience only, and that other name designations may be substituted therefor.

The SA3 Internet web site is responsible for validating and authenticating users and servers as well as generating key sets for secure communication sessions. This is a service that may be provided to by an independent third party.

The S3Q is a PCI board that has multiple adaptable independent hardware engines for hardware accelerating encryption and decryption algorithms during secure data communication sessions. Each S3Q may be assigned a unique ID and a unique internal secret non-readable key.

Each UAD user device, like each S3Q, contains a secret non-readable key that is not transmitted. UAD's can be any single or combination of anything from user ID and password, browser cookie, fingerprint ID, retina ID, Smart Card, or the QUICKFLEX SeQure Qard with hardware acceleration capability. The UAD is in electrical communication with the computer system of the user issuing data queries.

The system and method are unique in the manner in which the elements interact and the operational features of the entire system. First, data that has been encrypted using the system must pass through the server S3Q hardware in order to be translated in a form that users can understand. This hardware not only decrypts or deciphers the secured data on the server hard drive disk, but also re-encrypts the data in a way that only the intended validated recipients or users can decrypt. Unscrambled data does not appear and is not accessible outside of the S3Q hardware on the server machine. In the preferred embodiment, this cannot be circumvented through software alone.

Second, internal keys for securing data are kept secret and are not accessible or readable through software. Once again, this is inherent in the hardware design and cannot be circumvented through software alone. When keys do need to be stored outside of the hardware for storage or transmission, they are stored in independent encrypted forms to protect. Keys are not even accessible in a readable form on the SA3 web server, but are generated by hardware in a proprietary manner on demand.

Third, in the preferred embodiment in which reconfigurable hardware is incorporated, all keys and algorithms are updateable and changeable. Making such changes can be done without interruption of server service.

Lastly, this may all be done transparently to the user, except for any user validation information that may need to be provided for authenticating identity or establishing a secure session link with the user.

SA3: SeQure Authentication, Authorization and Administration Web Site

The SA3 web site is a service provided to both users and Internet servers for maintaining access to secure information. When a secure transaction or link is required between parties, each party is validated and authenticated through the service for each of the other parties.

Server, User, and Random Session Keys

As shown in FIG. 1, a reconfigurable computing board 100 installed within the SA3 server generates a random session key with Random Key Generator 101. This Random Session Key (RSK) is used to partially encrypt data before it is sent over the SeQure Link. The SA3 hardware accepts the Server ID IDA 110 and User ID IDB 120 publicly from each site being validated for the SeQure Link. During the validation process and by using Secret Key Generators A and B 111 and 121, secret keys SKA and SKB for both validated user sites can be generated. The algorithms of 111 and 121 may be different and kept confidential. These Secret Keys are also recoverable at the server and user sites through a separately defined encryption storage method kept proprietary and confidential. Once the SA3 server hardware regenerates SKA and SKB, the random session key RSK can be encrypted using both SKA and SKB by encryption functions 112 and 122 so that it may be transmitted to the server and user sites for establishing a secure link. The results are two Encrypted Session Keys, ESKA and ESKB, that may be transmitted publicly as shown by 113 and 123. Encryption functions 112 and 122 may be held as proprietary and kept as trade secrets as well.

Since secret keys SKA and SKB and RSK, as well as the algorithms to generate and protect them, are never made available outside of the hardware on any site, the task of recovering any of these keys is made difficult to nearly impossible by any hacker. In the unlikely event that the hacking community compromises the methods of secret key protection and generation, they can be independently changed and updated by the SA3 server site. In practice, it is desirable to periodically update key generation and protection methods and key values periodically anyway, to always stay one step ahead of a possible, although improbable hack attempt.

Publicly available session key information such as date, time, IDA, IDB, ESKA and ESKB are recorded into the SA3 server database in order to provide information for future key recovery on the part of servers and/or users if required at some future time. Options for both servers and users to specify the length of storing recovery information are made available to all registered users and service providers utilizing SeQure system protections.

Site Validation

When a secure link is requested, users submit to the SA3 web site their personal ID's, shown as IDA 110 and IDB 120 in FIG. 1. Either party may specify the level of authentication the other party is required to pass prior to establishing a secure link. By using the URL of the data to be accessed, this can be specified ahead of time by owners of proprietary information and data files. The SA3 server authenticates each party as specified using any number and combination of a variety of forms, including user ID and password, signatures contained in cookies, personalized smart cards, retina ID readers, fingerprint ID readers, Super Smart Qard ID's, or other means. Information for validating users is part of a SA3 web site available database maintained by a service provider. Information for validation of one party or the other need not be shared by either, protecting valuable personal ID information from being used in an unauthorized manner in the future.

The SA3 server services may be provided in a toll type manner for service providers. In other words, a toll count keeping track of the number of validations and session key generations performed for service providers that charge for their services can be maintained. A usage charge made to the service provider periodically may then be made for the service.

S3Q: SeQure Server Super Qard

In a preferred embodiment, the S3Q server board is a PCI board that is installed in a desktop or server unit that performs encryption and decryption tasks using hardware instead of through software. The benefits of a hardware solution over a software solution are significantly higher performance when processing large amounts of data as well as the ability to make it even more difficult for hacking software to monitor data flow in a system. In a server environment, hardware correlates to quick response time on the side of the user. In a preferred embodiment, the architecture of the server board may be similar to the Super Qard described in Quickflex Corporation's Quick Qard Reconfigurable Computing Patent Application, Ser. No.______, which is incorporated herein by reference in its entirety. Multiple (typically 4) existing reconfigurable computing devices are incorporated into the single Super Qard board with the following simple board hardware modifications from a PC Card Quick Qard design:

1. Minimum FPGA capacity is 100 k gate or larger part with additional I/O's used for host bus expansion to 64 bits.

2. All modules utilize the same clock signals

3. Single Flash for CIS for the entire board instead of one for each module

4. A PCI controller chip is embedded on the board. A large PLD or ASIC, perhaps with integrated PCI controller functionality, can replace the separate PLD's for each module, or they may remain separate.

5. Cable and PX bus pins used to provide buses between groups of 2, 4, and 8 modules. Piggyback connectors still present for future expansion capability.

6. Separate serial flash part (for each separate module) on unused I/O's of FPGA for factory Key storage.

The Quick Qard SW Driver for the SeQure Server Qard needs to be updated to include support for multiple modules by different application software instances and to manage the use of those modules on demand. The driver can then be ported over to a UNIX/LINEX environment so that a single solution for both MS Windows and LINEX can be offered.

Hardware configuration ‘.qqt’ files can be in an FPGA vendor-encrypted format to protect the files from being easily reverse engineered. Another layer of encryption for protection defined by the QQT driver may also exist. Even if the configuration hardware design was reverse engineered, it would not be enough to successfully hack data obtained from illegal entry of the server hard disk files that are encrypted.

It should be understood that, as used herein, “key” or “cipher” are used interchangeably to refer to a code, sequence or combination that may be used for encryption and decryption.

SKA Secret Key A

The secret key assigned by the S3Q SeQure Server Super Qard 200 is encrypted prior to being stored in the PCI board. In this way, if the key is updated through the Internet and intercepted, the key is not compromised. The method of Secret Key A encryption for transmission and storage into Flash memory device 204 may be kept secret from the server and user. A corresponding decryption function 201 used to decrypt the SKA is designed into the hardware of the S3Q SeQure Server Super Qard PCI board. The hardware is designed such that the internal recovered SKA is not accessible outside the hardware, so that it may be kept secret. The recovered SKA is used to drive the Pseudo-Random Noise generator A 202 in order to provide a sequence of data for both encrypting data that is to be written to the server HDD or decrypting data that is read from the server HDD prior to being re-encrypted for the user. Combiner 203 is used to combine or uncombine the data from the SKA driven Pseudo Random Noise Generator A. The algorithm of 202 and 203 may be kept as trade secrets within QUICKFLEX. A simple example of 202 would be a maximum linear feedback shift register using SKA as a seed value, although more complex better noise generators are certainly preferred. A simple example of combiner 203 would be a bus wide exclusive-OR gate, although more robust combiner functions may also be preferred. The combiner function may separate as shown or together with either block 202 or the other combiners 213 and 222.

Flash 204 used for Secret Key A storage is large enough to contain at least two, and possibly more than two key. Since the hardware used for functions 201, 202, and 203 is reconfigurable and changeable on the fly, providing room for more than one version of the key allows conversion of files from one version of keys and algorithms to another without requiring to bring down the server to do so.

RSK Random Session Key

The Random Session Key (“RSK”) is obtained from the publicly transmitted Encrypted Session Key A (“ESKA”) using the properly defined Random Session Key Decryption function 211 and the internally available Secret Key A (“SKA”). The algorithm of function 211 corresponds to the algorithm defined in Secret Key A Encryption function 112 and is kept confidential. A separate Pseudo-Random Noise generator R 212 is used to provide a pseudo random sequence to combiner 213 for encrypting or decrypting data.

SKB Secret Key B

The Secret Key B (SKB) is obtained from the publicly transmitted Encrypted Session Key B (ESKB) using the properly defined Random Session Key Decryption function 221 and the internally available recovered Random Session Key (RSK). The algorithm of function 221 corresponds to the algorithm defined in Secret Key B Encryption function 122 and may also be kept confidential. A separate Pseudo-Random Noise generator B 222 is used to provide a pseudo random sequence to combiner 223 for encrypting or decrypting data.

It is important to point out that the methods of protecting each of the 3 used keys (SKA, SKB, and RSK) can be different and the methods of providing Pseudo Random Noise in blocks 202, 212, and 222 may be different. The methods of combining data to key driven noise generator outputs shown in 203, 213, and 223 may be different as well.

As shown in FIG. 1, the encryption and decryption steps utilizing Random Session Key Decryption function 221 and separate Pseudo-Random Noise generator B 222 are optional operations on the server side process when sending or receiving data. These operations add an additional level of data security by encrypting data an additional time beyond just using the random session key by using the client's recovered secret key B as well. A person of ordinary skill in the art will appreciate that in applications in which processor demands are high, such as real-time video-streamed data, this optional block may be excluded in the preferred embodiment.

Server Data Storage

Sensitive data present on the server that needs to be protected is stored and kept on the server HDD 206. Not all data on this disk needs to be kept in a protected state, but only the files that need to be kept secret. Other forms of data, such as real time data streams may also be protected in a similar fashion. While processing data to and from the S3Q crypto engine, it can be stored in RAM 205 to allow block transfers which will accelerate overall system performance. When data is read from the RAM as shown 208, it will likely, but not necessarily, be transferred on the same bus as data to and from the HDD 207.

Discussion of Client-Side Process

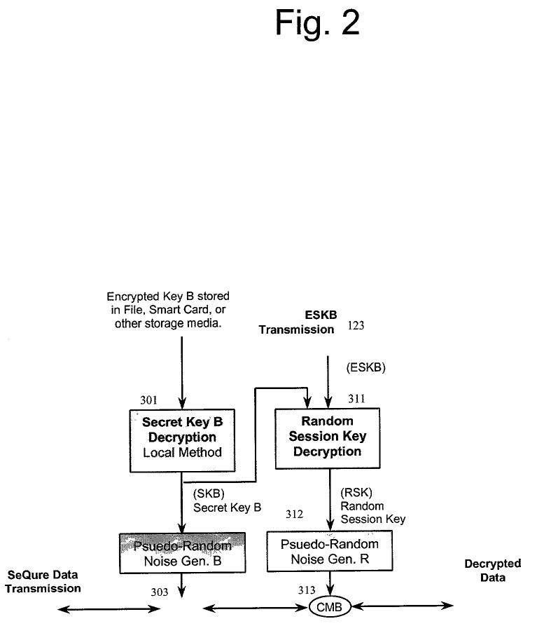

As shown in FIG. 2, the client's secret key B is stored in an encrypted form on the user's hard drive, smart card, security PC Card, or other client side storage media using the compliment process of the local secret key B decryption method shown in 301. This protects the actual secret key B from becoming compromised if the stored encrypted secret key B is discovered. On the client side, processing of key recovery and cryptography tasks 300 may be handled by software, or by hardware for an added level of protection and performance.

As on the server side for the local private key A, the local client private key B is recovered in the local method secret key B decryption process 301. Once Secret Key B (SKB) is recovered, it can be used to recover the Random Session Key (RSK) in process 311. When done in hardware, these processes can be kept secure within the hardware and not made accessible to the main client side processor bus. The RSK is used as input to Psuedo-Random Noise Generator R 312 to create a Pseudo-Random sequence that can be combined with data using combiner block 313 for encryption or decryption processes when data is transferred to or from the remote server.

Optional is an additional crypto process using Psuedo-Random Noise Generator B 302 and combiner block 303 for an additional level of data protection. This optional process corresponds to the optional process associated on the server side with blocks 221, 222 and 223, and provides an additional layer of encryption and concomitant security.

User Site Processing

It is not necessary for remote user interfacing to S3Q servers to process the functions as shown in 211-213, 221-223 in hardware, although it would may be faster and more secure than software implementation. By reverse engineering software solutions made available to users that perform these functions, it is theoretically possible for a hacker to gain an understanding of these trade secret methods. Therefore, different algorithms for these functions should be used with remote software users than remote hardware users in order to help protect the integrity of the algorithms of hardware function users. Also, a different SKA should be used for software users than with hardware users for the same reason.

Additional Considerations

If protected data needs to be processed on the server and not only stored, a secure data link to another processor board through the back end of the encryption engine can be used to insure that data between the secured data world and unsecured processing world remains secure. In other words, when data goes from the online storage portion of the server to the offline data processing portion of the server, data is always encrypted or decrypted when transferred and no straight link exists for hackers to gain direct access to the processing area. This would be the most secure method of protecting sensitive data. Of coarse, the system could be easily modified by designing HW that allows the non-scrambled data to be made accessible in the server for processing, which would not necessarily be as secure.

Since the hardware configuration files for the FPGA are changeable, protection algorithms can be changed at any time. If, a method of breaking a used algorithm is found, the SeQure site can update the server with a new method of encryption and the secured data files can be translated to the new method of encryption, all without interrupting service and transparent to users. It is even possible to use different algorithms for different user data, since additional header information of encrypted files indicate the configuration needed for that data.

A person of ordinary skill in the art will readily appreciate that the data security protection scheme described can be used in conjunction with other data processing tasks such as data compression, or for real-time, streaming audio/visual data, digital watermarking and fingerprint ID operations as well during data downloads.

Skilled artisans would appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

The foregoing discussion is included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

What is claimed is:

1. A method of securely storing and transmitting data between a data server and a client, said method comprising:
storing a first set of data on said data server, said first set of data being encrypted by a first private key;
establishing a set of rules for responding to a data request from said client, and storing said rules on said data server;
upon receiving said data request from said client, transmitting an authentication request from said data server to said security server;
authenticating said user responsive to said authentication request;
generating a first private key at said security server, said first private key associated with said data server;
generating a second private key at said security server, said second private key associated with said client; and
generating a session key at said security server.

2. The method of claim 1, further comprising:
encrypting said session key with said first private key, thereby generating a first encrypted session key;
encrypting said session key with said second private key, thereby generating a second encrypted session key;
transmitting said first encrypted session key and said second encrypted session key to said data server; and
transmitting said second encrypted session key to said client.

3. The method of claim 2, further comprising transmitting said second encrypted session key to said data server.

4. The method of claim 2, further comprising:
decrypting said session key using said first private key at said data server;
decrypting said second private key using said session key at said data server;
encrypting a second set of data, said second set of data being a subset of said first set of data and responsive to said data request, using said session key and said second private key, thereby generating a set of encrypted data;
transmitting said set of encrypted data to said client.

5. The method of claim 4, further comprising:
decrypting said session key using said second private key at said client;
decrypting said set of encrypted data using said session key at said client.

6. The method of claim 6, further comprising:
decrypting said set of encrypted data using said second private key at said client.

6. A system for securely storing and transmitting data comprising:
a data server, said data server having an encryption/decryption engine and a first private cipher, wherein said data server is configured to respond to a data request from said user device;
a user device in electrical communication with said data server for sending said data request and receiving a set of responsive data, said user device having a second private cipher; and
a security server having a third private cipher, said security server in communication with said user device and said data server, wherein said security server established a secure transmission link.

7. The system for securely transmitting data of claim 6, wherein said data server further comprises a PCI board for hosting the encryption/decryption engine.

8. The system for securely storing and transmitting data of claim 7, wherein said PCI board comprises an erasable memory for storing said second encryption key.

9. The system for securely storing and transmitting data of claim 8, wherein said erasable memory is flash memory.

10. The system for securely storing and transmitting data of claim 6, wherein said second private cipher is stored in said user device in a hardware format.

11. The system for securely storing and transmitting data of claim 6, wherein said third private cipher is randomly generated.

12. The system for securely storing and transmitting data of claim 11, wherein said randomly generated third private cipher is unique to a secure data transmission session.

13. The system for securely storing and transmitting data of claim 6, wherein said data server contains a set of files, and at least some of said files are encrypted using said first private cipher.

14. The system for securely storing and transmitting data of claim 13, wherein substantially all of said files are encrypted using said private cipher.

15. The system for securely storing and transmitting data of claim 6, wherein said first private cipher is not stored in memory.

16. The system for securely storing and transmitting data of claim 15, wherein said first private cipher is not accessible on any bus.

17. A method of creating a secure data transmission session comprising:
generating a random session key at a security server;
validating a data server and a user device requesting said secure data transmission session;
generating a first secret key for said data server;
generating a second secret key for said user device;
encrypting said random session key with said first secret key, resulting in a first encrypted random session key, and transmitting said first encrypted random session key to said data server;
encrypting said random session key with said second secret key, resulting in a second encrypted random session key, and transmitting said second encrypted random session key to said user device; and
transmitting data from said data sever to said user device via said secure data transmission session.

18. The method of claim 17, wherein said random session key is hardware generated.

19. The method of claim 18, wherein said hardware used for generating said random session key is reconfigurable.

20. The method of claim 17, wherein said first secret key is hardware generated.

21. The method of claim 20, wherein said hardware used for generating said first secret key is reconfigurable.

22. The method of claim 17, wherein said second secret key is hardware generated.

23. The method of claim 22, wherein said hardware used for generating said second secret key is reconfigurable.

24. The method of claim 17, further comprising decrypting said data using said random session key, said first secret key and said second secret key.
